(19) United States
(12) Patent Application Publication
(10) Pub. No.: US 2026/0215229 A1
(43) Pub. Date: Jul. 23, 2026

(54) METHOD AND SYSTEM FOR PREDICTING CHARACTERISTICS OF SEMICONDUCTOR DEVICES

(71) Applicant: Samsung Electronics Co., Ltd., Suwon-si (KR)

(72) Inventors: Suyeon Sohn, Suwon-si (KR); Sungwook Kim, Suwon-si (KR); Minkyu Kim, Suwon-si (KR); Kyubaik Chang, Suwon-si (KR); Jaehoon Jeong, Suwon-si (KR); Hanlim Choi, Suwon-si (KR)

(21) Appl. No.: 19/446,405

(22) Filed: Jan. 12, 2026

(30) Foreign Application Priority Data
Jan. 20, 2025 (KR) 10-2025-0008186
Feb. 5, 2025 (KR) 10-2025-0014709

(51) Int. Cl. H10P 74/00; G06F 30/27; G06F 30/392; H10P 74/20; G06F 119/18

(52) U.S. Cl. CPC H10P 74/238; G06F 30/27; G06F 30/392; H10P 74/203; H10P 74/207; G06F 2119/18

(57) ABSTRACT

A method of predicting characteristics of a semiconductor device includes: predicting structural information characteristics of the semiconductor device that is manufactured by reflecting conditions corresponding to a first process recipe from among a plurality of semiconductor processes, and predicting electrical characteristics of the semiconductor device based on the predicted structural information characteristics and conditions corresponding to a second process recipe from among the plurality of semiconductor processes, wherein the first process recipe and the second process recipe are different from each other.

### CROSS-REFERENCE TO RELATED APPLICATIONS

This application claims priority under 35 U.S.C. § 119 to Korean Patent Application Nos. 10-2025-0008186, filed on January 20, 2025, and 10-2025-0014709, filed on February 5, 2025, in the Korean Intellectual Property Office, the disclosures of which are incorporated by reference herein in their entirety.

### BACKGROUND

A semiconductor process consists of a large number of unit processes. To shorten a wafer manufacturing time, sampling measurements are conducted on only a portion of manufactured wafers. Such sampling measurements may result in a significant lack of measurement data, making it difficult to predict wafer quality.

To resolve these problems of measurement-based process management, interest has recently been focused on virtual metrology (VM). VM utilizes history data of equipment from the manufacturing process to predict measurement values for all wafers without actually performing measuring processes. Linking predicted measurement values through virtual metrology to a process control system may improve product quality and reduce manufacturing costs and manufacturing times.

### SUMMARY

Some aspects of the present disclosure provide enhancement of prediction of characteristics of a semiconductor device by utilizing a model that predicts virtual metrology data in advance.

For example, some aspects of the present disclosure provide methods of controlling semiconductor fabrication.

The method may include, based on first process conditions of a first process recipe for a first semiconductor fabrication process, predicting structural information of a semiconductor device fabricated using the first semiconductor fabrication process; based on the predicted structural information and second process conditions of a second process recipe for a second semiconductor fabrication process, predicting an electrical characteristic of the semiconductor device, wherein the semiconductor device is fabricated using the second semiconductor fabrication process, and wherein the first semiconductor fabrication process and the second semiconductor fabrication process are different from each other; and providing a control signal to a fabrication system based on the predicted electrical characteristic, to cause the fabrication system to modify at least one of the first process conditions or the second process conditions.

A method of predicting characteristics of a semiconductor device manufactured using a first semiconductor process and a second semiconductor process that are performed sequentially, the method comprising: inputting process conditions of the first semiconductor process into a first machine learning model; obtaining, as an output of the first machine learning model, virtual metrology data for a plurality of wafers on which the first semiconductor process is performed; inputting process conditions of the second semiconductor process and the virtual metrology data into a second machine learning model, wherein the first machine learning model and the second machine learning model are configured with a hierarchical model structure; and obtaining, as an output of the second machine learning model, electrical characteristic data for semiconductor devices obtained by performing the second semiconductor process on the plurality of wafers. .

Some aspects of the present disclosure provide systems for predicting characteristics of a semiconductor device.

The system includes at least one processor configured to execute a machine learning architecture, wherein the machine learning architecture has a hierarchical model structure including: a first machine learning model configured to: receive, as input, a plurality of first process conditions, and based on the plurality of first process conditions, predict and output virtual metrology data for a plurality of wafers to which the plurality of first process conditions are applied; and a second machine learning model configured to: receive, as input, a plurality of second process conditions and the virtual metrology data, and predict and output electrical characteristics for a plurality of semiconductor devices fabricated by applying the second process conditions to the plurality of wafers.

### BRIEF DESCRIPTION OF THE DRAWINGS

FIG. 1 is a diagram schematically illustrating an example of a method of manufacturing a semiconductor device;

FIG. 2 is a flowchart showing an example of a method of predicting characteristics of a semiconductor device;

FIG. 3 is a flowchart showing an example of a method of predicting characteristics of a semiconductor device;

FIG. 4 is a flowchart showing an example of a method of training a second model;

FIG. 5 is a flowchart showing examples of data input/output to an L1 model and an L2 model;

FIG. 6 is a block diagram showing examples of data input to the L1 model and the L2 model;

FIG. 7 is a diagram illustrating examples of data output at each process operation;

FIG. 8 is a diagram illustrating an example of first virtual metrology data, second virtual metrology data, and third virtual metrology data;

FIG. 9 is a diagram illustrating an example of training data and virtual metrology data;

FIG. 10 is a diagram showing an example of a system for predicting characteristics of a semiconductor device;

FIG. 11 is a block diagram illustrating a virtual metrology server of FIG. 10 in more detail; and

FIG. 12 is a block diagram illustrating a characteristic prediction server of FIG. 10 in more detail.

### DETAILED DESCRIPTION

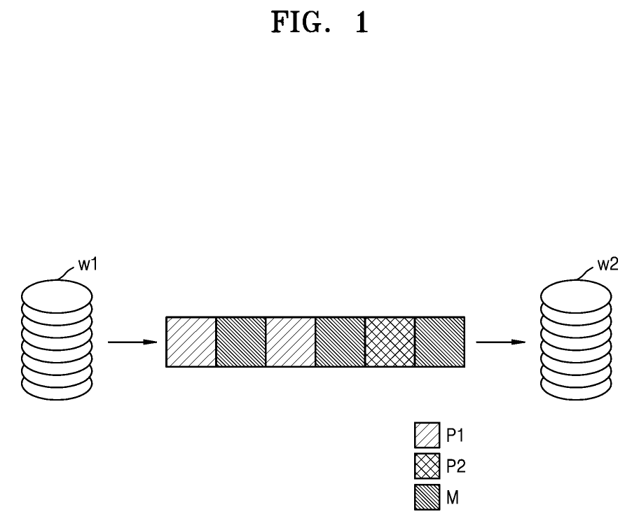

FIG. 1 is a diagram for schematically illustrating an example of a a method of manufacturing a semiconductor device.

A semiconductor device may be manufactured by performing hundreds of unit processes, including deposition processes, photolithography processes, etching processes, and planarization processes, on a silicon wafer to form a desired circuit pattern. For example, a deposition process may be performed to form a film on a wafer, a photolithography process may be performed to form a photoresist pattern on the wafer, an etching process may be performed to pattern the film formed on the wafer by using the photoresist pattern as an etching mask, and a planarization process may be performed to planarize the film formed on the wafer.

Wafers W1, which are the targets of semiconductor processes, are usually stored in wafer cassettes in units of lots and may be transported to process equipment that performs each unit process. A single lot may include up to 24 wafers. Each unit process may be performed on a lot-by-lot basis, or may be performed on each wafer extracted from the wafer cassette.

In some implementations, wafers W2, which are generated by performing a first semiconductor process P1 and a second semiconductor process P2 on the wafers W1, which are targets on which semiconductor processes are to be performed, may each include a plurality of semiconductor devices. In some implementations, each of the first semiconductor process P1 and the second semiconductor process P2 may further include a plurality of unit processes. In FIG. 1, each of the first semiconductor process P1 and the second semiconductor process P2 is shown as one block. However, this is for convenience of illustration, and it should be noted that the first semiconductor process P1 and the second semiconductor process P2 may each include a plurality of processes, not only one process.

The first semiconductor process P1 and the second semiconductor process P2 may be processes of different stages. For example, the first semiconductor process P1 may be a process for forming a semiconductor structure during a semiconductor process. For example, the second semiconductor process P2 may be a process for forming electrical characteristics of a semiconductor during a semiconductor process. In some implementations, the first semiconductor process P1 and the second semiconductor process P2 may be performed sequentially. The first semiconductor process P1 may be a process preceding the second semiconductor process P2. Examples of the first semiconductor process P1 and the second semiconductor process P2 will be described later.

Referring back to FIG. 1, when the first semiconductor process P1 and the second semiconductor process P2 are performed, measurement M may be performed after each process is completed. For example, during the measurement M, physical characteristics of wafers may be measured by measuring equipment MES. For example, wafers may be loaded onto optical critical dimension (OCD) measuring equipment. A method of measuring OCD may be a method of calculating the vertical profile of a vertical pattern formed on a wafer by inversely calculating the reflectivity and the phase information of light diffracted through the vertical pattern. OCD measuring equipment may measure vertical profiles such as depths and heights of patterns etched on a wafer. According to another example, wafers may be loaded onto a stage of a scanning electron microscope (SEM). A SEM may measure the horizontal profiles, such as width and lengths, of patterns formed on the wafer.

Physical characteristics measured by the measuring equipment MES may be the basis for predicting the electrical characteristics of semiconductor devices formed on a wafer and may be the basis for determining the quality of the semiconductor devices. However, measuring the physical characteristics of every wafer manufactured in a semiconductor process may increase the wafer manufacturing time. Therefore, virtual metrology may be performed by sampling some wafers to measure physical characteristics of sampled wafers and predicting measurement values for the remaining wafers without measuring physical characteristics of the remaining wafers. However, even when virtual metrology is used, data may only be obtained after the entire process is completed to obtain virtual metrology values, and thus it is difficult to perform virtual metrology during the intermediate process of a semiconductor process and to identify the characteristics of a semiconductor device.

As used herein, measurement may mean temporarily stopping a wafer process while the wafer process is in progress and actually loading a wafer through separate equipment to measure the condition of the wafer. As used herein, virtual metrology may mean virtually measuring the condition of a wafer based on process data obtained while performing process operations without stopping the process of the wafer. For example, virtual metrology may refer to a technology that uses virtual metrology sensors built into equipment while a process is in progress to detect generated plasma and convert measurement data into data related to the structure of a wafer (thickness, CD, etc.).

According to some implementations of the present disclosure, a method of predicting the characteristics of a semiconductor device based on virtual metrology data and data predicting the virtual metrology data without a separate process for the measurement M is disclosed.

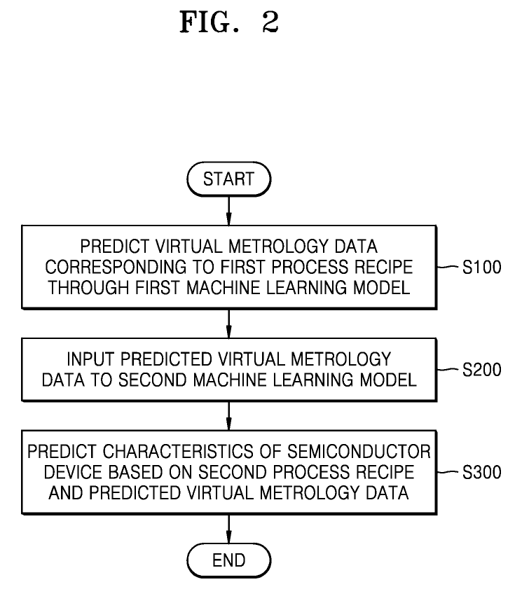

FIG. 2 is a flowchart showing an example of a method of predicting characteristics of a semiconductor device.

In some implementations, the method of predicting characteristics of a semiconductor device may operate based on a first machine learning model and a second machine learning model. Hereinafter, the first machine learning model may be referred to as a first model or an L1 model, and the second machine learning model may be referred to as a second model or an L2 model. Hereinafter, these terms will be used interchangeably.

The first machine learning model and the second machine learning model may include an artificial neural network (ANN). An ANN may refer to/include various computing systems based on a biological neural network that is modeled after a brain of an animal. In some implementations, the first machine learning model and the second machine learning model may include a convolutional neural network (CNN). However, the ANNs included in the first machine learning model and the second machine learning model are not limited thereto and may be implemented in various ways. For example, the first machine learning model and the second machine learning model may include a recurrent neural network (RNN). For example, the first machine learning model and the second machine learning model may be implemented based on a long short-term memory (LSTM) technique, a gated recurrent unit (GRU) technique, an attention technique, etc. Unlike classical algorithms that perform tasks according to predefined conditions like rule-based programming, an ANN may learn to perform tasks by considering a plurality of samples (or examples) (e.g., a plurality of pieces of input data). The ANN may have a structure in which artificial neurons (or neurons) are connected to one another, and connections between neurons may be referred to as synapses. A neuron may process a received signal and transmit a processed signal to other neurons through synapses. An output of a neuron may be referred to as "activation". A neuron and/or a synapse may have a variable weight, and the influence of a signal processed by a neuron may increase or decrease according to a weight. In particular, a weight related to an individual neuron may be referred to as a bias.

However, the first machine learning model and the second machine learning model are not limited to being based on an ANN, and may be implemented based on various learning methods and/or algorithms. For example, the first machine learning model and the second machine learning model may be implemented based on a random forest technique.

In operation S100, virtual metrology data corresponding to a first process recipe may be predicted through the first machine learning model. For example, the first model may be an artificial intelligence model that takes information regarding the first process recipe as input and virtual metrology data corresponding thereto as output. In some implementations, the first model may be an artificial intelligence model trained through information regarding process conditions for the first process recipe and result data that varies according to process conditions of each process recipe. In some implementations, the first model may be a learning model that predicts the values of virtual metrology data corresponding to each process condition. Through the first model, when process conditions for the first process recipe are input, virtual metrology data corresponding thereto may be output. Therefore, missing data in parts of a process that have been completed or data for future parts of a process that have not yet been completed may be predicted even when the entire process is yet completed. In some implementations, the virtual metrology data predicted in operation S100 may be data including structural information characteristics under each process condition. Data including structural information characteristics may be data including information such as numbers that may express the structure of a wafer that is changed depending on each process.

In operation S200, predicted virtual metrology data may be input into the second machine learning model. In some implementations, the second model may be an artificial intelligence model that takes virtual metrology data as input.

In operation S300, the characteristics of a semiconductor device may be predicted based on information regarding a second process recipe and predicted virtual metrology data. In some implementations, the second model may be an artificial intelligence model that takes process condition information regarding the second process recipe and virtual metrology data reflecting information regarding a previous process as input and the characteristics of a semiconductor device that change according to the input as output. For example, the characteristics of a semiconductor device may be electrical characteristics of the semiconductor device.

Accordingly, the first model and the second model having different process recipes as input are disclosed. Through the first model, virtual metrology data reflecting information regarding the first process recipe may be output, and the electrical characteristics of a semiconductor device may be predicted by using the virtual metrology data reflecting the information regarding the first process recipe and information regarding the second process recipe as inputs to the second model. In some implementations, the first process recipe may include process operations for forming a structure of a semiconductor device, and the second process recipe may include process operations for forming electrical characteristics of the semiconductor device. In some implementations, the first process recipe may correspond to a first semiconductor process, and the second process recipe may correspond to a second semiconductor process.

According to some implementations of the present disclosure, instead of (or in addition to) actual measurement information having a very high missing rate, virtual metrology data and data predicted from the virtual metrology data may be used to secure data directly reflecting information regarding the first process recipe, e.g., structural information, as input to the second model, and, by utilizing this for prediction of electrical characteristics, advanced characteristic prediction may be possible.

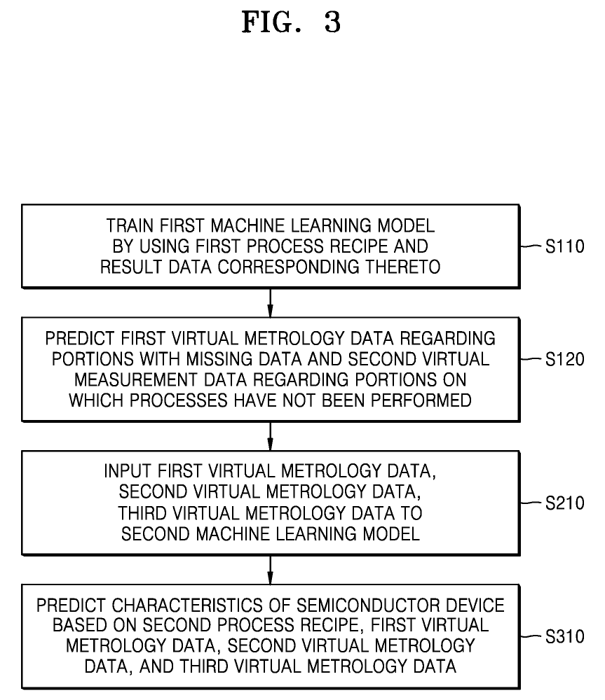

FIG. 3 is a flowchart showing an example of a method of predicting characteristics of a semiconductor device.

Operations S110 and S120 of FIG. 3 may be included in operation S100 of FIG. 2, operation S210 of FIG. 3 may be included in operation S200 of FIG. 2, and operation S310 of FIG. 3 may be included in operation S300 of FIG. 2.

In operation S110, the first machine learning model may be trained with conditions corresponding to the first process recipe and result data corresponding thereto. In some implementations, the first model may include a CNN model. In some implementations, the first model may learn the relationship between recipe data for operations of each process and measurement data corresponding thereto or virtual metrology data corresponding thereto. Training of the first model may be performed in each process operation. In some implementations, the first model may be trained to take each process condition as input and output virtual metrology data including corresponding structural information, to reflect the structural characteristics of a wafer that vary according to each process condition.

In operation S120, through the first model, first virtual metrology data regarding a portion where data is missing and second virtual metrology data regarding a portion where a process has not been performed may be predicted.

In the following example, it is assumed that there are 8 process operations and virtual metrology data is to be obtained in an operation of performing a third process. At this time, a first process and a second process may be completed, the third process may be in progress, and fourth to eighth processes may be incomplete.

At this time, virtual metrology data may be obtained based on process data obtained in the first process and the second process. This may be data obtained by calculating process data obtained through process operations rather than data predicted through the first model. This is referred to as third virtual metrology data.

Although the first process and the second process have been completed, there may be cases where corresponding measurements are missing. In this case, virtual metrology data for the corresponding processes may be predicted through the first model. This predicted virtual metrology data may be referred to as first virtual metrology data.

Since the third process is in progress, virtual metrology data may not yet exist for wafers on which the third process is not yet performed and for data from the fourth process (and later processes). In this case, virtual metrology data for a corresponding process may be predicted through the first model. This predicted virtual metrology data may be referred to as second virtual metrology data.

According to some implementations of the present disclosure, virtual metrology data transmitted to the second model may include the first virtual metrology data, the second virtual metrology data, and third virtual metrology data. The first virtual metrology data and the second virtual metrology data may be virtual metrology data output through the first model, and the third virtual metrology data may be virtual metrology data calculated and obtained based on data obtained by actually performing a process.

Referring to operation S210, the first virtual metrology data, the second virtual metrology data, and the third virtual metrology data may be input into the second model. Therefore, all virtual metrology data containing structural information for all processes may be used as input to the second model.

In operation S310, the characteristics of the semiconductor device may be predicted based on the second process recipe and first to third virtual metrology data. In some implementations, the electrical characteristics of a semiconductor device may be predicted and output by using process conditions corresponding to the second process recipe and the first virtual metrology data, the second virtual metrology data, and third virtual metrology data as inputs of the second model.

In some implementations, virtual metrology data including structural information may be predicted and output through the first model, the virtual metrology data may be utilized as an input of the second model, and, by utilizing process information forming electrical characteristics as an input of the second model, the first model may learn (or be trained to output) structural information and the second model may learn (or be trained to output) electrical characteristic information. Effective learning may be achieved through the hierarchical model structure. Accordingly, the electrical characteristics of a semiconductor device may be predicted and analyzed through virtual metrology data including process condition data and structural information from among data generated during a semiconductor manufacturing process.

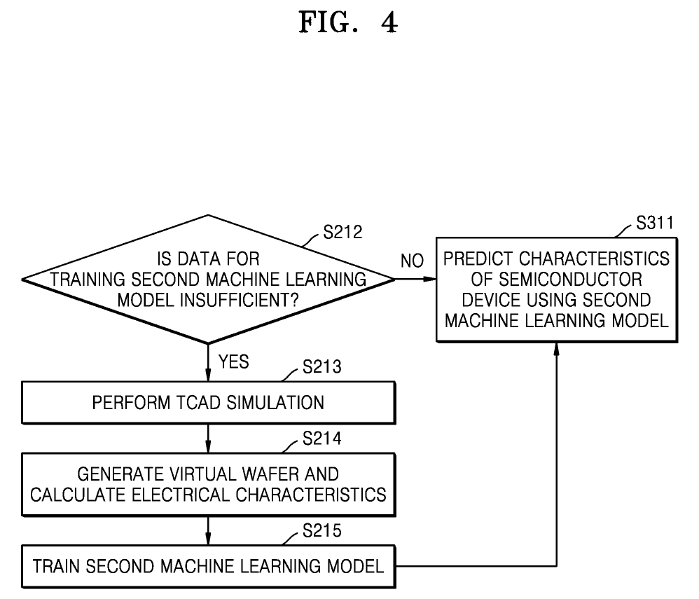

FIG. 4 is a flowchart showing an example of a method of training a second model.

Operations S212, S213, S214, and S215 of FIG. 4 may be included in operation S200 of FIG. 2. Operation S311 of FIG. 4 may be included in operation S300 of FIG. 2.

Operations S212, S213, S214, and S215 of FIG. 4 may be applied in the process for training the second machine learning model.

In operation S212, a system including the second machine learning model may determine whether there is a lack of data for training the second machine learning model. In some implementations, a minimum amount of input data may be needed for the second machine learning model to learn to output accurate output values. However, when the minimum amount of input data is not met, additional data may be needed for training. In operation S212, it may be determined whether the amount of data input for which the second machine learning model is to be trained is satisfactory.

When the amount of input data to be learned by the second machine learning model is not sufficient and it is determined that there is insufficient data (Y), a technology computer aided design (TCAD) simulation may be performed in operation S213. The TCAD simulation, which reproduces the 3-dimensional (3D) structure of a transistor by simulating semiconductor processes or devices, may reduce time and costs for development by predicting the performance and the defect rate of semiconductor devices at a layout design stage. In some implementations, the TCAD simulation may be performed by using a TCAD simulator. The TCAD simulation may be simulated based on process conditions corresponding to the second process recipe and virtual metrology data of a wafer including structural information.

In operation S214, a virtual wafer may be generated by reflecting the simulation in operation S213. Based on a generated virtual wafer, electrical characteristics may be calculated. Through this, process conditions corresponding to the second process recipe for training the second machine learning model, and training data including virtual metrology data and electrical characteristics of a wafer including structural information may be generated. These may be used to train the second machine learning model in operation S215.

In some implementations, operations S212 to S215 may be performed repeatedly a plurality of number of times. In some implementations, it may also be possible to perform training by weighting the TCAD simulation data generated according to operations S212 to S215.

When it is determined that there is sufficient data for training the second machine learning model (N), device characteristics may be predicted by using the second machine learning model in operation S311.

Accordingly, a hierarchical model structure that enables step-by-step learning and improves prediction performance by utilizing the first machine learning model that outputs virtual metrology data including structural information and the second machine learning model trained by using TCAD simulation is proposed.

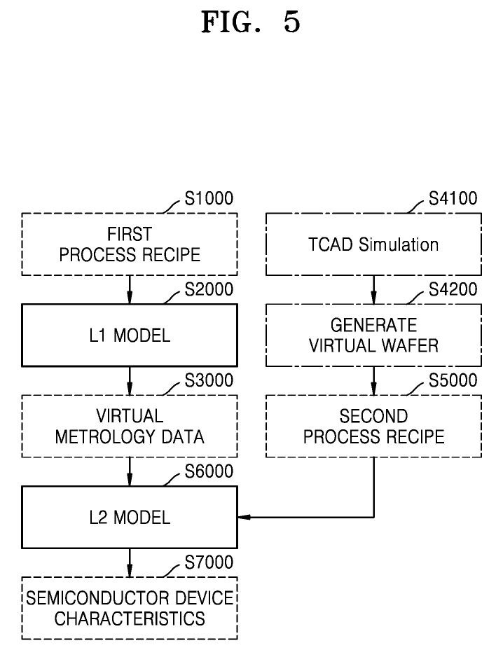

FIG. 5 is a flowchart showing an example of data input/output to an L1 model and an L2 model.

Referring to FIG. 5, process conditions corresponding to a first process recipe S1000 may be input into an L1 model S2000. In some implementations, the first process recipe S1000 may include process conditions in a process operation for forming a structure of a semiconductor device. In some implementations, the first process recipe S1000 may include process conditions in one or more of a photo process, an etching process, a deposition process, a cleaning process, a planarization process, a diffusion process, or a metal wiring process. The L1 model S2000 may receive process conditions according to a plurality of processes as inputs to predict and output virtual metrology data S3000 according to the inputs. The L1 model S2000 may output first virtual metrology data obtained by predicting data regarding a process that has been performed without measurement and second virtual metrology data obtained by predicting data for which a process has not been performed. In some implementations, in the case of third virtual metrology data generated by calculating process data obtained as a process is performed, the third virtual metrology data may not be output through the L1 model S2000 and may be output through the first process recipe S1000. In other words, the L1 model S2000 may predict and output virtual metrology data representing the structure of a wafer that reflects conditions corresponding to the first process recipe S1000. For example, the L1 model S2000 may be a model that learns a structure-related process from among semiconductor processes and outputs a result thereof.

Virtual metrology data in operation S3000 may include first virtual metrology data, second virtual metrology data, and third virtual metrology data. Virtual metrology data in operation S3000 may be transferred as input to an L2 model S6000.

For the L2 model S6000, process conditions corresponding to a second process recipe S5000 may be input. In some implementations, the second process recipe S5000 may include process conditions according to an annealing process and an ion implantation process. In some implementations, process conditions for the annealing process may include temperature conditions, and process conditions for the ion implantation process may include doping conditions, energy conditions, etc.

In some implementations, for training the L2 model S6000, a virtual wafer to which the second process recipe is applied may be generated (operation S4200) through a TCAD simulation S4100. In some implementations, when training of the L2 model S6000 is needed, the L2 model S6000 may be trained by using simulation data obtained through a TCAD simulation rather than actual measurement data, thereby increasing the accuracy of the L2 model S6000.

The L2 model S6000 may output electrical characteristics S7000 of a semiconductor device by using conditions and the virtual metrology data S3000 corresponding to the second process recipe S5000 as inputs.

In some implementations, to directly utilize measurement values that have a significant influence on the characteristics of a device as X factors of the L2 model S6000, virtual metrology data and data predicted from the same may be used instead of actual measurement values having a high missing rate. Therefore, parameter reduction of training data does not occur, and loss of structural information closely related to device characteristics may be minimized, thereby enabling advanced characteristic prediction.

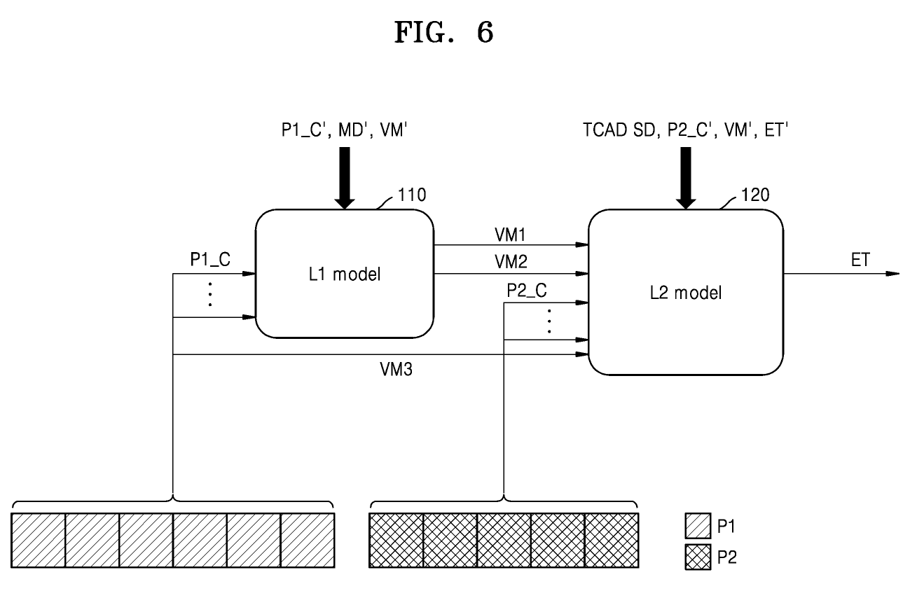

FIG. 6 is a block diagram showing an example of data input to the L1 model and the L2 model.

In FIG. 6, data indicated by thick arrows may refer to data input to each model for training, and data indicated by thin arrows may refer to data input for prediction of each model and data output as a result of prediction.

In some implementations, a first model 110 may perform learning through first process conditions P1_C' corresponding to the first semiconductor process P1, measurement data MD' measured according to the first process conditions P1_C', and virtual metrology data VM' predicted according to the first process conditions P1_C'. In some implementations, the first model 110 may be trained to receive the first process conditions P1_C' as inputs and output either the measurement data MD' of a wafer measured according to the first process conditions P1_C' or the virtual metrology data VM' according to the first process conditions P1_C'. The first model 110 according may include a 1D CNN model. In some implementations, by utilizing the 1D CNN model, it is possible to facilitate learning of time-series patterns between process operations.

In some implementations, the output of the first model 110 may be the input of a second model 120. In some implementations, the input of the first model 110 may be process conditions P1_C corresponding to the first semiconductor process P1. In some implementations, the first semiconductor process P1 may be a process for forming a structure of a semiconductor device. Examples of the first semiconductor process P1 may include a photo process, an etching process, etc., and the process conditions P1_C corresponding to the first semiconductor process P1 may include process conditions in the photo process, process conditions in the etching process, etc. Process conditions may refer to pre-set values set when carrying out a corresponding semiconductor process. As input to the first model 110, conditions of a process for forming a structure of a semiconductor device may be input, and, as output of the first model 110, virtual metrology data including structural information of a wafer formed by reflecting the process conditions for forming the structure of the semiconductor device may be output.

In some implementations, the virtual metrology data, which is the output of the first model 110, may be data including the structural information of the wafer. In some implementations, the virtual metrology data, which is the output of the first model 110, may be data obtained by converting a change over time of a particular wavelength from optical emission spectroscopy (OES) occurring during an etching process into the thickness of a film. In some implementations, the virtual metrology data may be data representing the depth of a recessed region according to an end point resulting from an OES occurring during the etching process. In some implementations, the virtual metrology data may be data that includes values that may be obtained from OES that occurs during a process. Examples of virtual metrology data appearing as an output of the first model 110 may not be limited thereto, and may include data that may include structural information of a semiconductor process, e.g., data regarding the thickness, the depth, the height, the length, etc. of at least one pattern formed through each process, and may include all structural parameters that may be measured in each of a plurality of processes of a semiconductor device.

In some implementations, first virtual metrology data VM1 and second virtual metrology data VM2 may be output through the first process conditions P1_C input through the first model 110. In some implementations, the first virtual metrology data VM1 and the second virtual metrology data VM2 may be values predicted through the first model 110. The first virtual metrology data VM1 may be result data obtained by performing virtual metrology on a wafer in a process operation where data is missing (e.g., for a process that has been performed but for which corresponding measurement data and/or virtual metrology data is not available), and the second virtual metrology data VM2 may be result data obtained by performing virtual metrology on a wafer for a process operation that has not yet been performed.

The third virtual metrology data VM3 may be virtual metrology data predicted or obtained based on process data processed through the first semiconductor process P1, rather than being output through the first model 110.

Referring to FIG. 6, the first model 110 may predict and output values for wafers for which data is not predicted and does not exist at the time of operating the first model 110, and prediction may not be performed for process operations for which data already exists.

In some implementations, the second model 120 may perform learning through second process conditions P2_C', the virtual metrology data VM', and electrical characteristic data ET' corresponding to the second semiconductor process P2. In some implementations, the second model 120 may be trained to receive the second process conditions P2_C' and the virtual metrology data VM' according to the second process conditions P2_C' as inputs and output the electrical characteristic data ET' of a semiconductor device. The second model 120 may include, but is not limited to, a fully connected layer. In some implementations, TCAD simulation data TCAD SD may optionally be input as data for training the second model 120. In some implementations, there may be a situation where it is difficult to secure the electrical characteristic data ET' of a semiconductor device, and thus the absolute number of training data for training the second model 120 may be insufficient. In such a case where there is insufficient training data, overfitting issues may occur. Therefore, in some implementations, when the number of pairs of training data is less than or equal to a set number of pairs of training data, the TCAD simulation data TCAD SD may be generated and used as training data. The TCAD simulation data TCAD SD is a result of applying second process conditions and virtual metrology data and may generate a virtual wafer and measure the electrical characteristic values of a generated virtual wafer. Through the process, data pairs for training may be generated, and the data pairs may be additionally input into the second model 120 to perform training.

In some implementations, the second model 120 may use the first virtual metrology data VM1, the second virtual metrology data VM2, and third virtual metrology data VM3 as first inputs and second process conditions P2_C corresponding to the second semiconductor process P2 as second inputs. In some implementations, the second semiconductor process P2 may be a process for forming electrical characteristics of a semiconductor device. In some implementations, the second semiconductor process P2 may include an annealing process and an ion implantation process. The second process conditions P2_C may include process conditions in the annealing process and process conditions in the ion implantation process. In some implementations, by inputting the second process conditions P2_C related to the electrical characteristics of the semiconductor device to the second model 120 to apply the second process conditions P2_C to virtual metrology data VM1, VM2, and VM3 reflecting the structural information according to a result of completing the first semiconductor process P1, electrical characteristics ET of the semiconductor device may be predicted and output.

In some implementations, by inputting all virtual metrology data without missing values in each process operation reflecting preceding structural information to the second model 120, the overfitting issue may be avoided, and the electrical characteristics of the semiconductor device may be output with higher accuracy. Also, even when the semiconductor process is not yet completed, virtual metrology data reflecting structural information may be obtained through the L1 model, and thus, even when a problem occurs, preemptive measures may be taken during the process, thereby significantly reducing the defect rate.

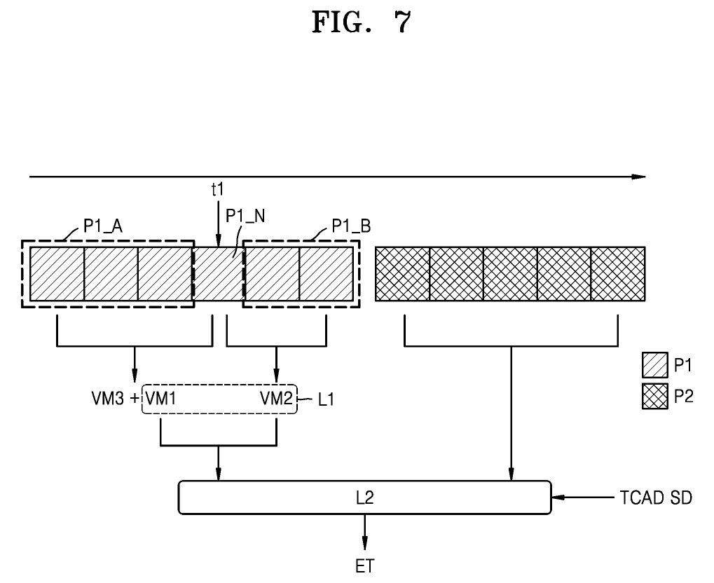

FIG. 7 is a diagram illustrating examples of data output at each process operation.

Referring to FIG. 7, an example in which a plurality of first semiconductor processes P1 and a plurality of second semiconductor processes P2 are sequentially performed is shown. In some implementations, a case in which it is desired to predict the characteristics of a semiconductor device at a time point t1 when an N-th process operation P1_N from among the plurality of first semiconductor processes P1 is in progress. At this time, it is assumed that a plurality of individual process operations may be performed in parallel on M wafers. M may be a natural number greater than or equal to 1.

Since the N-th process operation P1_N is in progress, processes P1_A preceding the N-th process operation P1_N have all been completed, and processes P1_B following the N-th process operation P1_N may not have yet been performed.

Virtual metrology data regarding processes P1_A preceding the N-th process operation P1_N may be values that have already been calculated and determined. This may be third virtual metrology data VM3. When third process operations are completed for the M wafers, the total number of pieces of data may ideally be 3*M. However, even when the third process operations have already been completed, there may be cases where the number of pieces of the third virtual metrology data VM3 is less than 3*M. This may include cases where data is missing or not measured due to equipment issues, etc. In this case, it is possible to predict virtual data corresponding to missing wafers in a process that has already been completed. This may be the first virtual metrology data VM1. In some implementations, the first virtual metrology data VM1 may be obtained by using process conditions corresponding to missing data as inputs to a first model L1.

Virtual metrology data regarding processes P1_B following the N-th process operation P1_N may be values that have not yet been determined. In this case, it is possible to predict virtual data corresponding to wafers in a process that will be completed in the future. This may be the second virtual metrology data VM2. In some implementations, the second virtual metrology data VM2 may be obtained by using process conditions corresponding to the processes P1_B following the N-th process operation P1_N as inputs to the first model L1.

The first virtual metrology data VM1 and the second virtual metrology data VM2 obtained through the first model L1 and the third virtual metrology data VM3 obtained through the processes P1_A preceding the N-th process operation P1_N may be input into a second model L2. Therefore, all virtual metrology data including the structural information of the wafer corresponding to respective operations of the first semiconductor process P1 may be utilized as the X factor of the second model L2.

In some implementations, the output of the first model L1 may be virtual metrology data interpolated for missing parts when missing parts occur in a process operation, and virtual metrology data output by the first model L1 may differ according to prediction time points.

The second model L2 may additionally receive process conditions for the second semiconductor process P2 as inputs and output the electrical characteristics ET. In some implementations, the second model L2 may receive TCAD simulation data and utilize the same for learning.

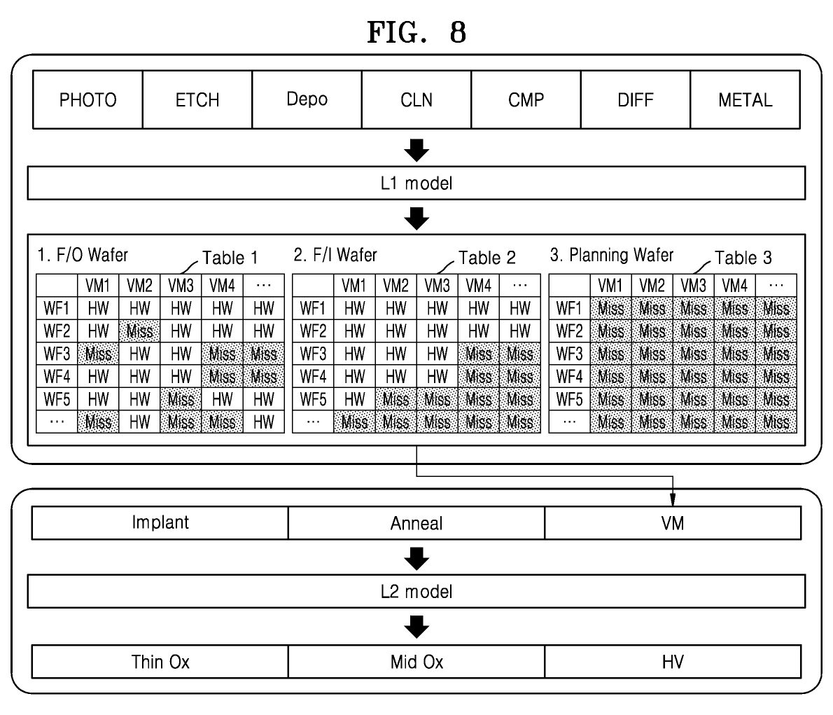

FIG. 8 is a diagram illustrating an example of first virtual metrology data, second virtual metrology data, and third virtual metrology data.

In some implementations, FIG. 8 illustrates data input to and output from the L1 model and the L2 model. As input to the L1 model, process conditions corresponding to a plurality of first semiconductor processes may be input. In some implementations, the plurality of first semiconductor processes may include, but are not limited to, a photo process PHOTO, an etching process ETCH, a deposition process DEPO, a cleaning process CLN, a planarization process CMP, a diffusion process DIFF, and a metal formation process METAL. The first semiconductor processes that may be input into the L1 model may be any one of the processes that contribute to formation of the structure of a semiconductor device. The L1 model may output first virtual metrology data or second virtual metrology data based on the conditions of the first semiconductor processes.

Referring to FIG. 8, Table 1 showing the status of wafers that have been fab-out (F/O) as outputs of the L1 model, Table 2 showing the status of wafers that have been fab-in (F/I), and Table 3 showing the status of planning wafers that are scheduled to be fab-in are shown.

Table 1 shows a plurality of wafers WF1, WF2, WF3, WF4, WF5, and so on in the vertical direction of the Table 1 and corresponding virtual metrology data VM1, VM2, VM3, VM4, and so on in the horizontal direction of the Table 1 Virtual metrology data VM1, VM2, VM3, and VM4 shown along the horizontal axis in Tables Table 1, Table 2, and Table 3 refers to virtual metrology values corresponding to respective process conditions. In Table 1, VM1 refers to virtual metrology data representing structural information on each wafer after completing the photo process. VM2 refers to virtual metrology data representing structural information on each wafer after completing the etching process. VM3 refers to virtual metrology data representing structural information on each wafer after completing the deposition process. VM4 refers to virtual metrology data representing structural information on each wafer after completing the cleaning process. A portion indicated as HW may mean that data is secured as measurement data or virtual metrology data, and a portion indicated as Miss may mean that virtual metrology data does not exist.

Referring to Table 1 of FIG. 8, it may be confirmed that the virtual metrology data VM2 data corresponding to a second wafer WF2, the virtual metrology data VM1 data and the virtual metrology data VM4 data corresponding to a third wafer WF3, the virtual metrology data VM4 data corresponding to a fourth wafer WF4, and the virtual metrology data VM3 data corresponding to a fifth wafer WF5 are missing. The L1 model may predict and output first virtual metrology data corresponding to a portion of Table 1 marked as Miss.

Table 2 of FIG. 8 shows the state in which process operations corresponding to the virtual metrology data VM1 to VM4 are all completed for a first wafer WF1 and the second wafer WF2, process operations corresponding to virtual metrology data VM1 to VM3 are all completed, for the third wafer WF3 and the fourth wafer WF4, and process operations corresponding to the virtual metrology data VM1 are all completed for the fifth wafer WF5. In this case, since there is no missing data for process operations that have already been completed as in Table 1, prediction of the first virtual metrology data may not be necessary. In some implementations, the L1 model may output second virtual metrology data by predicting data in process operations that have not been performed, e.g., after the virtual metrology data VM4 for the third wafer WF3 and the fourth wafer WF4 and after the virtual metrology data VM2 of the fifth wafer WF5.

Referring to Table 3 of FIG. 8, a case is disclosed where process operations have not yet been performed on all of wafers and are scheduled to be performed. In this case, since there is no data corresponding to all process conditions for all wafers, all values may be predicted and the second virtual metrology data may be output.

Through the process, all virtual metrology data may be secured as the output of the L1 model, not only for wafers on which process operations have already been performed, but also for wafers on which process operations are being performed and wafers on which process operations are scheduled to be performed. Therefore, the structural data of wafers to which all process conditions are applied may be secured as virtual metrology data. Accordingly, since virtual metrology data as the X factor input to the L2 model is secured for all process conditions, the accuracy for predicting the electrical characteristics of a semiconductor device may be further increased.

Referring to FIG. 8, process conditions (Implant) corresponding to the ion implantation process, process conditions (Anneal) corresponding to the annealing process, and virtual metrology data VM are input as inputs to the L2 model, and thus data representing the electrical characteristics of a semiconductor device may be output. In some implementations, data representing the electrical characteristics of a semiconductor device may include, but is not limited to, the threshold voltage and the leakage current of the semiconductor device. As the output of the L2 model, various factors that may represent the electrical characteristics of a semiconductor device may be output.

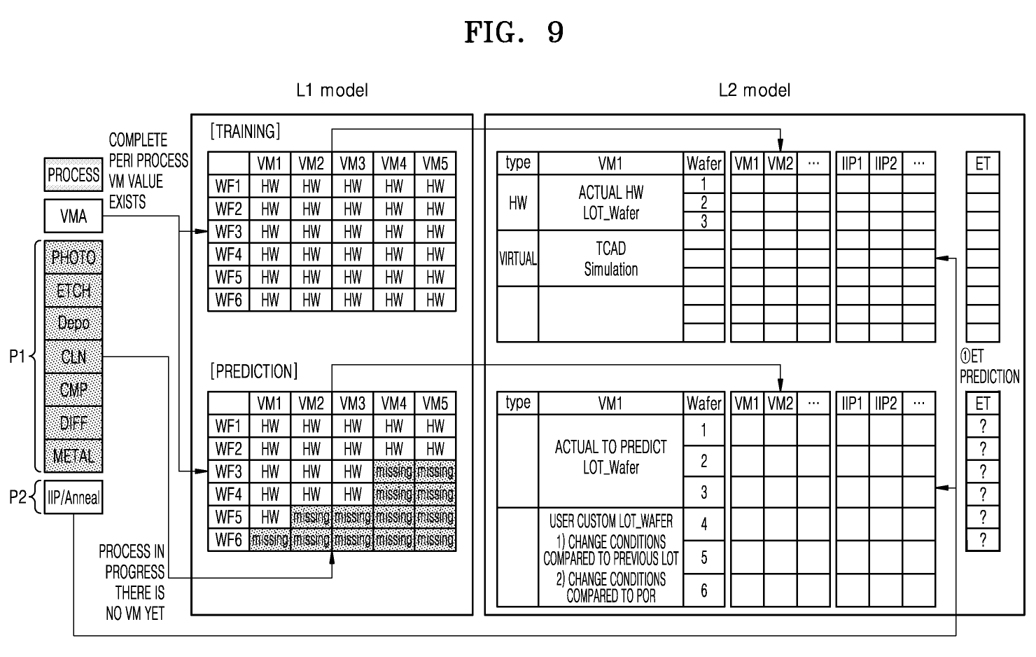

FIG. 9 is a diagram illustrating examples of training data and virtual metrology data.

Referring to FIG. 9, training data and prediction data of the L1 model and training data and prediction data of the L2 model are shown.

Referring to the left table of FIG. 9, examples of processes corresponding to the first semiconductor process P1 and processes corresponding to the second semiconductor process P2 are shown. In some implementations, prior to starting the processes corresponding to the first semiconductor process P1, a process for performing virtual metrology VMA may be performed. In some implementations, the L1 model may be trained by inputting virtual metrology data with corresponding process conditions into the L1 model in the corresponding operation.

In the table included in the L1 model, the vertical axis represents a wafer being processed, and the horizontal axis represents virtual metrology data values corresponding to respective processes. In the L1 model, training may be performed based on data values resulting from applying conditions of each process operation to each wafer. In some implementations, the training of the L1 model may be based on actually measured data or on data obtained by performing virtual metrology. In some implementations, recipe data regarding a product process and virtual metrology data corresponding thereto may be retrieved from a database containing Fab information and used for training.

Referring to the L1 model of FIG. 9, in a process already in progress, virtual metrology data may be predicted and output for a portion corresponding to a wafer and process conditions for which virtual metrology data has not yet been obtained. In this way, virtual metrology data predicted and output through the L1 model may become input values for the L2 model.

Referring to the L2 model, the virtual metrology data values used for training the L1 model may be used as training data for training the L2 model. Data used for training the L2 model may be electrical characteristics ET values obtained by inputting virtual metrology data values corresponding to actual wafers and process conditions corresponding to the second semiconductor process P2. In some implementations, there may be cases where there are insufficient data values for training the L2 model.

In this case, TCAD simulation data, which is virtual data, may be additionally utilized for training the L2 model. TCAD simulation data may be used to generate data pairs needed for training by generating a virtual wafer with some process conditions applied by using a TCAD simulator and calculating the electrical characteristics of the virtual wafer. Therefore, the training accuracy of the L2 model may be improved.

From the prediction perspective of the L2 model, electrical characteristics may be predicted by inputting the second process conditions to be applied to actual wafers to be predicted and the virtual metrology data predicted by the L1 model. Also, electrical characteristics may be predicted by applying different conditions by inputting a wafer custom-generated by a user rather than an actual wafer to be predicted as input to the L2 model.

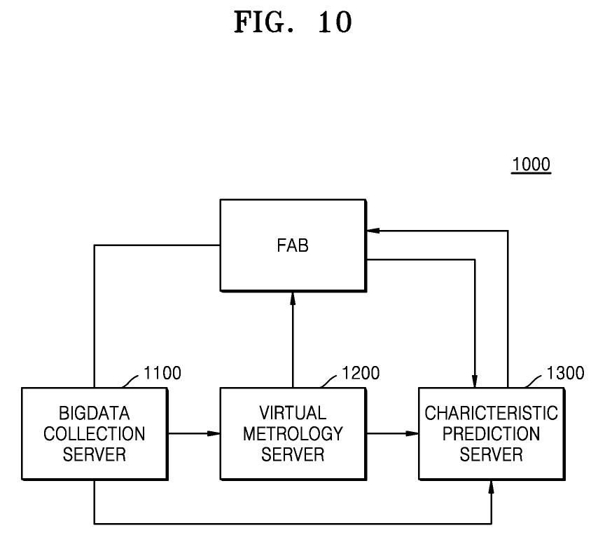

FIG. 10 is a diagram showing an example of a system for predicting characteristics of a semiconductor device.

Referring to FIG. 10, a characteristic prediction system 1000 may include a big data collection server 1100, a virtual metrology server 1200, and a characteristic prediction server 1300.

The big data collection server 1100, the virtual metrology server 1200, and the characteristic prediction server 1300 may each include a processor and a memory. The processor controls the overall operation of a server and may access the memory to execute instructions loaded into the memory. The big data collection server 1100, virtual metrology server 1200, and characteristic prediction server 1300 may communicate with one another based on wired and wireless communication protocols.

The big data collection server 1100 may collect and store log data and actual measurement values from a semiconductor FAB. Log data may include process path information for wafers manufactured in a semiconductor FAB. Also, the actual measurement values may include measured values of one or more physical characteristics of sample wafers from among manufactured wafers. Wafers manufactured in a semiconductor fab may be assigned identifiers, and the log data and the actual measurement values may be managed based on the identifiers of the wafers in the big data collection server 1100. In some implementations, the big data collection server 1100 may store process conditions corresponding to log data and actual measurement values together.

The virtual metrology server 1200 may obtain log data, actual measurement values, and process conditions from the big data collection server 1100. The virtual metrology server 1200 may generate predicted values regarding physical characteristics based on log data of unmeasured target wafers.

The virtual metrology server 1200 may independently perform virtual metrology on various types of physical characteristics on a single wafer. For example, the virtual metrology server 1200 may perform virtual metrology of a first physical characteristic by using actual measurement values and log data of first sample wafers from among wafers manufactured in a semiconductor FAB, the first sample wafers for which the first physical characteristic is measured. Also, the virtual metrology server 1200 may perform virtual metrology of a second physical characteristic by using actual measurement values and log data of second sample wafers from among wafers manufactured in a semiconductor FAB, the second sample wafers for which the second physical characteristic is measured. Some of the first sample wafers and the second sample wafers may overlap each other.

In some implementations, the virtual metrology server 1200 may include a first model and may train the first model based on virtual metrology data calculated by the virtual metrology server 1200. The first model may predict and output virtual metrology data by using the first process conditions as input.

The characteristic prediction server 1300 may predict electrical characteristics based on actual measurement values obtained from the big data collection server 1100 and predicted values obtained from the virtual metrology server 1200. In some implementations, a control signal based on a result of prediction of the electrical characteristic by the characteristic prediction server 1300 may be fed back to the semiconductor FAB. The semiconductor FAB may adjust process conditions of process equipment included in a process path or maintain the process equipment based on the control signal.

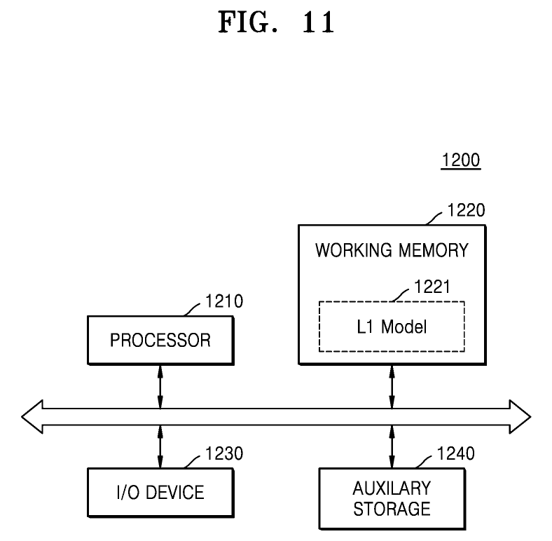

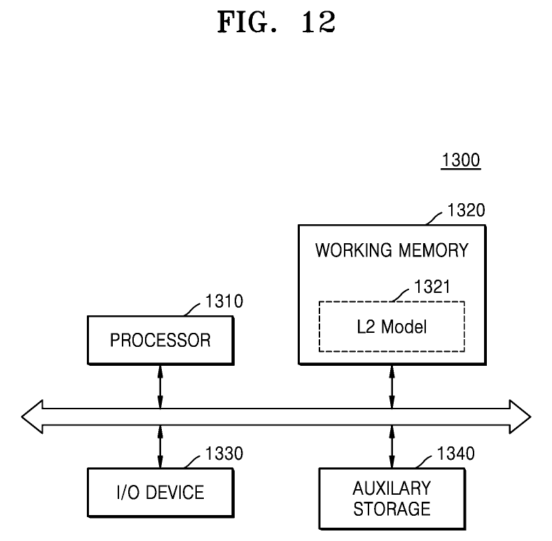

FIGS. 11 and 12 are block diagrams showing examples of the virtual metrology server and characteristic prediction server of FIG. 10 in more detail.

Referring to FIG. 11, the virtual metrology server 1200 may include at least one processor 1210, a working memory 1220, an input/output device 1230, and an auxiliary storage device 1240 connected to a system bus. Referring to FIG. 12, the characteristic prediction server 1300 may include at least one processor 1310, a working memory 1320, an input/output device 1330, and an auxiliary storage device 1340 connected to a system bus. The processor 1210, the working memory 1220, the input/output device 1230, and the auxiliary storage device 1240 included in the virtual metrology server 1200 respectively correspond to the processor 1310, the working memory 1320, the input/output device 1330, and the auxiliary storage device 1340 included in the characteristic prediction server 1300, and thus any duplicate descriptions will be omitted.

The virtual metrology server 1200 may be provided as a dedicated device for virtual metrology. For example, the virtual metrology server 1200 may include a program for virtual metrology. The processor 1210, the working memory 1220, the input/output device 1230, and the auxiliary storage device 1240 are electrically connected to one another and may exchange data with one another through a system bus.

The processor 1210 may be implemented to execute at least one instruction. For example, the processor 1210 may be implemented to execute software (applications, operating systems (OS), device drivers) to be executed on the virtual metrology server 1200. The processor 1210 may execute an OS loaded into the working memory 1220. The processor 1210 may execute various application programs that will be driven based on the OS. For example, the processor 1210 may be a central processing unit (CPU), a microprocessor, an application processor (AP), or any similar processing device. The processor 1210 may execute a machine learning architecture. The machine learning architecture may include a hierarchical model structure. The machine learning architecture may include a first machine learning model and the second machine learning model. In some implementations, the processor 1210 may receive a plurality of process conditions as input data and provide a machine learning model that predicts characteristics of a semiconductor device based on received input data. In some implementations, the virtual metrology server 1200 may include an L1 model 1221 and may predict and output virtual metrology data corresponding to a first process condition. Virtual metrology data output through the L1 model 1221 may be virtual metrology data including structural information. In some implementations, the characteristic prediction server 1300 may include an L2 model 1321 and may predict electrical characteristics of wafers that have not been measured by using virtual metrology data and second process conditions output from the L1 model 1221 as inputs of the L2 model 1321. Descriptions of the first model and the second model given above with reference to FIGS. 1 to 10 may be applied to the L1 model 1221 and the L2 model 1321 shown in FIGS. 11 and 12.

The working memory 1220 may be implemented to store at least one instruction. For example, the working memory 1220 may be loaded with an OS or application programs. When the virtual metrology server 1200 is booted, an OS image stored in the auxiliary storage device 1240 may be loaded into the working memory 1220 according to a boot sequence. All input/output operations of the virtual metrology server 1200 may be supported by the OS. Similarly, applications may be loaded into the working memory 1220 to be selected by a user or to provide basic services. For example, the L1 model 1221 including instructions for performing virtual metrology on physical characteristics of a wafer may be loaded into the working memory 1220.

Also, the working memory 1220 may be a volatile memory such as a dynamic random access memory (DRAM), a static random access memory (SRAM), etc., or a non-volatile memory such as a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), etc.

The input/output device 1230 may obtain log data of manufactured wafers and actual measurement values of sample wafers. Also, the input/output device 1230 may output predicted values of target wafers generated by virtual metrology.

The auxiliary storage device 1240 may be provided as a storage medium for the virtual metrology server 1200. The auxiliary storage device 1240 may store application programs, OS images, and various data. The auxiliary storage device 1240 may be provided in the form of a large-capacity storage device such as a memory card (MMC, eMMC, SD, Micro SD, etc.), a hard disk drive (HDD), a solid state drive (SSD), a universal flash storage (UFS), etc.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While certain examples have been particularly shown and described, it will be understood that various changes in form and details may be made therein without departing from the spirit and scope of this disclosure.

What is claimed is:

1. A method of controlling semiconductor fabrication, the method comprising:
based on first process conditions of a first process recipe for a first semiconductor fabrication process, predicting structural information of a semiconductor device fabricated using the first semiconductor fabrication process;
based on the predicted structural information and second process conditions of a second process recipe for a second semiconductor fabrication process, predicting an electrical characteristic of the semiconductor device, wherein the semiconductor device is fabricated using the second semiconductor fabrication process, and
wherein the first semiconductor fabrication process and the second semiconductor fabrication process are different from each other; and
providing a control signal to a fabrication system based on the predicted electrical characteristic, to cause the fabrication system to modify at least one of the first process conditions or the second process conditions.

2. The method of claim 1, wherein the predicted structural information comprises at least one of a length, a depth, or a thickness of a feature of the semiconductor device, and
wherein the predicted electrical characteristic comprises at least one of a voltage or a current of the semiconductor device.

3. The method of claim 1, wherein the predicted structural information comprises predicted first virtual metrology data characterizing a result of the first semiconductor fabrication process on a first wafer of a plurality of wafers on which the first semiconductor fabrication process has been completed,
wherein measured metrology data or virtual metrology data for the first semiconductor fabrication process is available for a second wafer of the plurality of wafers and unavailable for the first wafer.

4. The method of claim 2, wherein the predicted structural information comprises second virtual metrology data characterizing a result of the first semiconductor fabrication process on the semiconductor device, wherein the first semiconductor fabrication process has not been performed on the semiconductor device when the predicted structural information is predicted.

5. The method of claim 2, wherein:
the first semiconductor fabrication process is configured to form a structure on a wafer, and
the second semiconductor fabrication process is configured to define electrical characteristics of the semiconductor device.

6. The method of claim 5, wherein the first semiconductor fabrication process comprises at least one of a photo process, a deposition process, an etching process, a planarization process, or a cleaning process.

7. The method of claim 5, wherein the second semiconductor fabrication process comprises at least one of an annealing process or an ion implantation process.

8. A method of predicting characteristics of a semiconductor device manufactured using a first semiconductor process and a second semiconductor process that are performed sequentially, the method comprising:
inputting process conditions of the first semiconductor process into a first machine learning model;
obtaining, as an output of the first machine learning model, virtual metrology data for a plurality of wafers on which the first semiconductor process is performed;
inputting process conditions of the second semiconductor process and the virtual metrology data into a second machine learning model,
wherein the first machine learning model and the second machine learning model are configured with a hierarchical model structure; and
obtaining, as an output of the second machine learning model, electrical characteristic data for semiconductor devices obtained by performing the second semiconductor process on the plurality of wafers.

9. The method of claim 8, wherein the virtual metrology data comprises structural information of the plurality of wafers.

10. The method of claim 8,
wherein the first semiconductor process is configured to form structures on the plurality of wafers, and
wherein the second semiconductor process is configured to define electrical characteristics of the plurality of wafers.

11. The method of claim 8, wherein the virtual metrology data comprises virtual metrology data for a wafer, of the plurality of wafers, for which (i) measured data corresponding to the first semiconductor process and (ii) virtual metrology data based on process measurements of the first semiconductor process, are unavailable.

12. The method of claim 8, wherein the first semiconductor process has not been performed on the plurality of wafers when the plurality of wafers when the virtual metrology data is obtained.

13. The method of claim 8, comprising training the second machine learning model, wherein training the second machine learning model comprises:
performing a technology computer aided design (TCAD) simulation;
generating a virtual wafer by applying the TCAD simulation; and
generating training data by testing the virtual wafer.

14. The method of claim 13, wherein training the second machine learning model comprises training the second machine learning model using the training data.

15. The method of claim 8, comprising further inputting, into the second machine learning model, virtual metrology data that is obtained by converting a change over time of a particular wavelength obtained from optical emission spectroscopy (OES) into a thickness of a film.

16. A system for predicting characteristics of a semiconductor device,
wherein the system comprises at least one processor configured to execute a machine learning architecture,
wherein the machine learning architecture has a hierarchical model structure comprising:
a first machine learning model configured to:
receive, as input, a plurality of first process conditions, and
based on the plurality of first process conditions, predict and output virtual metrology data for a plurality of wafers to which the plurality of first process conditions are applied; and
a second machine learning model configured to:
receive, as input, a plurality of second process conditions and the virtual metrology data, and
predict and output electrical characteristics for a plurality of semiconductor devices fabricated by applying the second process conditions to the plurality of wafers.

17. The system of claim 16, wherein:
the first process conditions comprise conditions of semiconductor fabrication operations configured to form structures on the plurality of wafers, and
the second process conditions comprise conditions of semiconductor fabrication operations configured to define electrical characteristics of the plurality of wafers.

18. The system of claim 16, wherein the virtual metrology data output by the first machine learning model comprises:
first virtual metrology data for a semiconductor fabrication process that has been performed on the plurality of wafers; and
second virtual metrology data for a semiconductor fabrication process scheduled to be performed on the plurality of wafers after the virtual metrology data is predicted and output.

19. The system of claim 18, wherein the second machine learning model is further configured to receive, as input, third virtual metrology data obtained through measurement of the first process conditions.

20. The system of claim 16, wherein the second machine learning model is a machine learning model trained by using technology computer aided design (TCAD) simulation data.
